(19) United States
(12) Patent Application Publication
(10) Pub. No.: US 2024/0014404 A1
(43) Pub. Date: Jan. 11, 2024

(54) CURRENT COLLECTOR, ELECTROCHEMICAL APPARATUS USING CURRENT COLLECTOR AND ELECTRONIC DEVICE

(71) Applicant: Ningde Amperex Technology Limited, Ningde (CN)

(72) Inventor: Xiaobing YANG, Ningde (CN)

(73) Assignee: Ningde Amperex Technology Limited, Ningde (CN)

(21) Appl. No.: 18/371,642

(22) Filed: Sep. 22, 2023

Related U.S. Application Data
(63) Continuation of application No. PCT/CN2021/082530, filed on Mar. 24, 2021.

(51) Int. Cl. H01M 4/66; H01M 10/052

(52) U.S. Cl. CPC H01M 4/667; H01M 4/668; H01M 10/052; H01M 2004/021

(57) ABSTRACT

A current collector includes: an organic support layer; a conductive layer; an intermediate coating disposed between the organic support layer and the conductive layer, wherein the intermediate coating includes a resin composition at least including a first resin and a second resin; the adhesion of the first resin to the organic support layer is less than the adhesion of the second resin to the organic support layer; the adhesion of the first resin to the conductive layer is less than the adhesion of the second resin to the conductive layer.

### CROSS REFERENCE TO THE RELATED APPLICATION

This application is a continuation under 35 U.S.C. § 120 of international patent application PCT/CN2021/082530 filed on Mar. 24, 2021, the entire content of which is incorporated herein by reference.

### TECHNICAL FIELD

The present application relates to the technical field of energy storage, and in particular to a current collector, an electrochemical apparatus using the current collector and an electronic device.

### BACKGROUND

Secondary batteries represented by lithium-ion batteries are widely used in various consumer electronics products, electric vehicles, large-scale energy storage devices required by wind energy and solar energy, and other fields due to their advantages such as high energy density, high output power, long cycle life, low self-discharge rate, and low environmental pollution. With the further development of social science and technology and the continuous expansion of the application range of secondary batteries, people have put forward higher and higher requirements for the energy density of secondary batteries.

In the related art, the current collector runs through the entire processing process of a battery and serves the entire life cycle of the battery. It is the carrier of the active material of the battery and provides a channel for electron transmission. It is an important part of the secondary battery and is closely related to the energy density of the battery. However, there is still room for improvement in the current collecting performance of the current collector in the related art or its effect in improving the energy density of the secondary battery. Correspondingly, the energy density of the secondary battery is also expected to be further improved. For example, the existing secondary battery uses a metal current collector on the one hand. Due to the characteristics (e.g., low elongation at break) of the metal material, when the thickness of the current collector is reduced to a certain level, the current collector is prone to fracture, damage and other adverse phenomena, resulting in waste of raw materials, reduced production capacity, and the like. So a metal current collector with a large thickness and high density is adopted, which, however, disadvantageously reducing the energy density of the battery. On the other hand, a composite current collector is adopted. A metal polymer film is obtained by physical vapor deposition of a metal on the surface of a low-density polymer film and a composite current collector is formed, which can reduce the density of the battery current collector and improve the gravimetric energy density of the battery. However, the adhesion between the metal on the surface of the composite current collector obtained by vapor deposition and the polymer film is low. During the processing of an electrode plate and the life cycle of a battery, a conductive layer on the surface of the composite current collector usually peels off, which seriously affects the cycle and storage performance of the battery. Therefore, after long-term cycles (≥1000 cycles) and high-temperature storage (≥85° C.), secondary batteries using existing composite current collectors have problems such as metal layer peeling off and accelerated cell capacity decay.

Therefore, there is a need for improvements in current collectors and electrochemical apparatus in the related art.

### SUMMARY

The inventors of the present application have carried out a lot of research, aiming at improving the traditional current collector, so that the current collector can reduce or avoid the delamination phenomenon occurring in a composite current collector while having good electrical conductivity and current collection performance, and can improve adhesion between layers in the composite current collector, thereby providing an electrochemical apparatus that can simultaneously achieve high gravimetric energy density and good comprehensive electrochemical performance.

Therefore, the primary application objective of the present application is to provide a current collector. A second application objective of the present application is to provide an electrochemical apparatus using the current collector and an electronic device.

According to a first aspect of the present application, provided is a current collector, including an organic support layer, a conductive layer and an intermediate coating, wherein the conductive layer is disposed on at least one surface of the organic support layer, and the intermediate coating is disposed between the organic support layer and the conductive layer.

The intermediate coating includes a resin composition, and the resin composition includes a first resin and a second resin; the adhesion of the first resin to the organic support layer is less than the adhesion of the second resin to the organic support layer; the adhesion of the first resin to the conductive layer is less than the adhesion of the second resin to the conductive layer.

In the above current collector, the adhesion of the first resin to the organic support layer is within a range of 1.8N/15 mm to 2.5N/15 mm, further within a range of 2.1N/15 mm to 2.3N/15 mm: the adhesion of the second resin to the organic support layer is within a range of 3.5N/15 mm to 7.5N/15 mm, further within a range of 4.0N/15 mm to 5.0N/15 mm.

In the above current collector, the adhesion of the first resin to the conductive layer is within a range of 2.0N/15 mm to 5.5N/15 mm, further within a range of 4.0N/15 mm to 5.0N/15 mm;
the adhesion of the second resin to the conductive layer is within a range of 3.5N/15 mm to 7.5N/15 mm, further within a range of 4.0N/15 mm to 5.5N/15 mm.

In the above current collector, a difference between a swelling ratio of the second resin in an electrolyte and a swelling ratio of the first resin in the electrolyte is greater than or equal to 3% by mass, further greater than or equal to 14% by mass, based on soaking in the electrolyte with a temperature of 85° C. for 72 h.

In the above current collector, a solubility parameter of the intermediate coating ranges from 7.5 to 12; a thermal expansion coefficient of the intermediate coating ranges from 50×10⁻⁶K⁻¹ to 80×10⁻⁶ K⁻¹.

In the above current collector, the first resin includes at least one of polyacrylic resin (PAA), modified polyolefin resin (MPO) and organic silicone resin (OS), and the second resin includes at least one of polyacrylate (PEA), polyurethane (PU), unsaturated polyester (UP), phenolic resin (PF), ethylene-acrylic acid copolymer (EAA), ethylene-vinyl acetate copolymer (EVA) and epoxy resin (EPO).

In the above current collector, the first resin includes epoxy resin (EPO), and the second resin includes at least one of polyacrylate (PEA), polyurethane (PU), unsaturated polyester (UP), phenolic resin (PF), ethylene-acrylic acid copolymer (EAA), and ethylene-vinyl acetate copolymer (EVA).

In the above current collector, the mass ratio of the first resin to the second resin in the intermediate coating is within a range of 2:98 to 98:2; further, the mass ratio of the first resin to the second resin is within a range of 10:90 to 90:10; the first resin is a modified polyolefin resin, the second resin is polyurethane and/or epoxy resin, and the mass percent of the second resin in the resin composition is within a range of 2% to 30%; the thickness of the intermediate coating is within a range of 0.2 μm to 2 μm.

In the above current collector, the organic support layer includes an organic polymer, and the organic polymer includes at least one of polyethylene, polypropylene, polyethylene terephthalate, polybutylene terephthalate, polyethylene naphthalate, polyparaphenylene terephthalamide, polyimide, polycarbonate, polyetheretherketone, polyoxymethylene, poly(p-phenylene sulfide), poly(p-phenylene ether), polyvinyl chloride, polyamide, polytetrafluoroethylene, polyvinylidene fluoride, and polystyrene; the thickness of the organic support layer is within a range of 2 μm to 36 μm.

In the above current collector, a material of the conductive layer includes at least one of a metal conductive material and a carbon-based conductive material; the metal conductive material includes at least one of aluminum, copper, nickel, iron, titanium, silver, gold, cobalt, chromium, molybdenum, and tungsten, and the carbon-based conductive material includes at least one of graphite, acetylene black, graphene and carbon nanotubes; the thickness of the conductive layer is within a range of 100 nm to 5000 nm; the conductive layer is a vapor deposition layer.

In the above current collector, the conductive layer includes a first conductive layer and a second conductive layer, and the first conductive layer and the second conductive layer are respectively disposed on two surfaces of the organic support layer;
the intermediate coating includes a first intermediate coating and a second intermediate coating;
the first conductive layer, the first intermediate coating, the organic support layer, the second intermediate coating, and the second conductive layer are sequentially stacked.

According to a second aspect of the present application, provided is an electrochemical apparatus, including a positive electrode, a negative electrode and an electrolyte, wherein the positive electrode and/or the negative electrode includes the current collector as described in the first aspect of the present application.

According to a third aspect of the present application, provided is an electronic device, including the electrochemical apparatus as described in the second aspect of the present application.

The current collector provided by the present application is a composite current collector including an organic support layer, an intermediate coating and a conductive layer, wherein the intermediate coating disposed between the organic support layer and the conductive layer includes a resin composition at least consisting of a first resin and a second resin. The adhesion of the first resin in the resin composition to the organic support layer and the conductive layer is less than the adhesion of the second resin to the organic support layer and the conductive layer, so the electrolyte swelling resistance of the first resin is better than that of the second resin. As a result, the composite resin system constructed gives full play to the electrolyte resistance of the first resin and the adhesion of the second resin to flexibly adjust the interface bonding and electrolyte tolerance of the intermediate coating and the composite current collector, thereby reducing or avoiding the delamination problem of the current collector during the operation of a battery. This is beneficial to improving the stability and reliability of the current collector during use and ensures that the current collector can maintain good electrical conductivity and current collection performance during the use of the electrochemical apparatus.

The electronic device of the present application includes the electrochemical apparatus provided by the present application, and thus at least has the same advantages as the electrochemical apparatus.

### BRIEF DESCRIPTION OF DRAWINGS

For clear description of the technical solutions in the embodiments of the present application, the accompanying drawings required to be used in the description of the embodiments will be briefly introduced below. For those skilled in the art, other drawings can also be obtained based on these drawings without creative effort.

FIG. 1 shows a schematic structural diagram of a current collector according to an embodiment of the present application.

FIG. 2 shows a schematic structural diagram of a current collector according to another embodiment of the present application.

### REFERENCE NUMERALS

10—conductive layer;
101—first conductive layer;
102—second conductive layer;
20—intermediate coating;
201—first intermediate coating,
202—first intermediate coating;
30—organic support layer.

### DETAILED DESCRIPTION

For clear understanding of the objectives, technical solutions and beneficial technical effects of the present application, the present application will be described in further detail below in conjunction with embodiments. It should be understood that the embodiments described herein are only for explaining the present application, not for limiting the present application.

For brevity, only certain numerical ranges are explicitly disclosed herein. However, any lower limit may be combined with any upper limit to form a range not expressly recited, any lower limit can be combined with any other lower limit to form an unexpressed range, and likewise any upper limit can be combined with any other upper limit to form an unexpressed range. In addition, every point or individual value between the endpoints of a range is included within that range, although not expressly stated herein. Thus, each point or individual value may serve as its own lower or upper limit to combine with any other point or individual value or with other lower or upper limits to form a range not expressly recited.

Unless defined otherwise, all technical and scientific terms used herein have the same meanings as are commonly understood by those skilled in the technical field to which the present application belongs. The terms used in the description of the present application are only for the purpose of describing specific embodiments, and are not intended to limit the present application.

The above summary of the present application is not intended to describe each disclosed embodiment or every implementation in the present application. The following description more particularly exemplifies exemplary embodiments. At various places throughout the present application, guidance is provided through a series of embodiments, and these embodiments can be used in various combinations. In each example, the lists are presented as representative groups only and should not be construed as exhaustive.

The current collector, electrochemical apparatus and electronic device of the present application will be described in detail below with reference to the drawings and specific embodiments.

[Current Collector]

A first aspect of the present application provides a current collector, which can reduce its own weight compared with traditional metal current collectors and also can improve the stability and reliability of the structure compared with traditional composite current collectors. Therefore, the current collector of the present application can simultaneously achieve low weight, good electrical conductivity, good current collection and stable and reliable structure, which is conducive to enabling the electrochemical apparatus including the current collector to simultaneously achieve high gravimetric energy density and good comprehensive electrochemical performance.

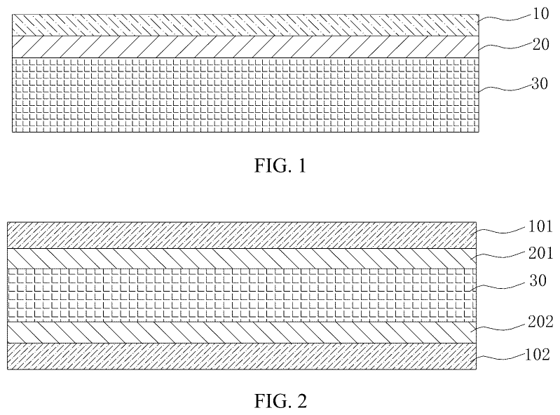

FIG. 1 schematically shows a current collector as an example. Referring to FIG. 1, the current collector includes an organic support layer 30, an intermediate coating 20 and a conductive layer 10 that are stacked, where the intermediate coating 20 is disposed between the organic support layer 30 and the conductive layer 10, the intermediate coating 20 includes a resin composition at least consisting of a first resin and a second resin, the adhesion of the first resin to the organic support layer 30 is less than the adhesion of the second resin to the organic support layer 30, and the adhesion of the first resin to the conductive layer 10 is less than the adhesion of the second resin to the conductive layer 10.

Herein, adhesion and bonding have the same meaning, so adhesion may also be called bonding.

In the above current collector, the intermediate coating 20 is disposed between the conductive layer 10 and the organic support layer 30, and the intermediate coating 20 can play a role in connecting the conductive layer 10 and the organic support layer 30, and the interlayer adhesion can be improved by arranging the intermediate coating 20. Further, the embodiment of the present application adopts the resin composition at least including the first resin and the second resin, and the adhesion of the first resin to the organic support layer 30 is less than the adhesion of the second resin to the organic support layer 30, and the adhesion of the first resin to the conductive layer 10 is less than the adhesion of the second resin to the conductive layer 10, so the electrolyte swelling resistance of the first resin is better than that of the second resin. The combination of the two resins can effectively improve the interface bonding and achieve strong electrolyte resistance. As a result, the falling-off phenomenon of the conductive layer of the current collector during the electrode plate processing and the life cycle of an electrochemical apparatus such as a secondary battery can be reduced or avoided and the secondary battery can achieve good cycle performance and storage performance.

Specifically, the first resin and the second resin in the intermediate coating 20 have different bonding to the organic support layer 30, different bonding to the conductive layer 10, and different electrolyte resistance. For example, in some cases, the adhesion of the first resin to the organic support layer 30 is less than the adhesion of the second resin to the organic support layer 30, the adhesion of the first resin to the conductive layer 10 is less than the adhesion of the second resin to the conductive layer 10, and the electrolyte swelling resistance of the first resin is better than that of the second resin. By adjusting the segment composition and the resin ratio, the performance advantages of each resin component can be given a full play, and the composite resin system constructed can be used to enhance the interface bonding of the composite current collector and improve the electrolyte swelling resistance. Therefore, compared with the existing composite current collector, the current collector of the embodiments of the present application can reduce or avoid a delamination problem during the electrode plate processing or the operation of the battery, and can improve the stability and reliability in use, thereby ensuring that the current collector can maintain good electrical conductivity and current collection performance during the use of the electrochemical apparatus. In addition, compared with the existing metal current collector, the current collector of the embodiment of the present application is significantly reduced in its weight, generally by about 50%, thereby improving the gravimetric energy density of the battery.

Therefore, using the current collector of the embodiment of the present application can simultaneously achieve low weight, good electrical conductivity, good current collection, and stable and reliable structure.

In some embodiments, the adhesion of the first resin to the organic support layer is within a range of 1.8N/15 mm to 2.5N/15 mm, and the adhesion of the second resin to the organic support layer is within a range of 3.5N/15 mm to 7.5N/15 mm. In some embodiments, the adhesion of the first resin to the organic support layer is within a range of 1.9N/15 mm to 2.4N/15 mm, and the adhesion of the second resin to the organic support layer is within a range of 4.0N/15 mm to 7.0N/15 mm. In some embodiments, the adhesion of the first resin to the organic support layer is within a range of 2.1N/15 mm to 2.3N/15 mm, and the adhesion of the second resin to the organic support layer is within a range of 4.0N/15 mm to 5.0N/15 mm. For example, in some embodiments, the adhesion of the first resin to the organic support layer can be 1.8N/15 mm, 1.9N/15 mm, 2.0N/15 mm, 2.1N/15 mm, 2.2N/15 mm, 2.3N/15 mm, 2.4N/15 mm or 2.5N/15 mm, and the adhesion of the second resin to the organic support layer can be 3.5N/15 mm, 3.6N/15 mm, 3.7N/l 5 mm, 3.8N/15 mm, 4.0N/15 mm, 4.1N/15 mm, 4.2N/15 mm, 4.3N/15 mm, 4.4N/15 mm, 4.5N/15 mm, 4.6N/15 mm, 4.8N/15 mm, 4.9N/15 mm, 5.0N/15 mm, 5.5N/15 mm, 6.0N/15 mm, 7.0N/15 mm or 7.5N/15 mm. When the adhesions of the first resin and the second resin to the organic support layer respectively meet the above ranges, it is beneficial to enhancing the interface adhesion of the composite current collector and the supporting role of the organic support layer can be given a full play, thereby ensuring that the current collector has good structural stability and working stability so that the current collector has a long service life.

The adhesion of the resin to the organic support layer can be determined by methods known in the art. As an example, the exemplary test method of the adhesion of the resin to the organic support layer is as follows: (1) Sample preparation. Corona treatment is performed on a 12 μm PET (polyethylene terephthalate) film, and a well mixed mixture of resin (such as the first resin or the second resin) and a curing agent is applied to the surface of the corona-treated PET film, and dried at a certain temperature to form a coating with a thickness of 1 μm. (2) An EAA (ethylene acrylic acid copolymer) hot-melt adhesive with a thickness of about 80 μm and the 12 μm PET film are hot pressed by a hot press LCP200-A2008N for 30 s at 85° C., 0.7 MPa. (3) The above-mentioned sample with a coating is cut into a 2 cm×10 cm sample strip and wiped clean with dust-free paper moistened with absolute ethanol. (4) Release paper on the surface layer of the hot-pressed EAA is peeled off, and the adhesive surface is aligned with the cut sample with a coating and then hot pressed by the hot press for 45 s at 85° C., 0.7 MPa. (5) A double-sided tape is stuck on a steel plate with a length of 125±mm, a width of 50±mm, and a thickness of 1.5-2 mm and release paper is then peeled off, and a base film side of the composite sample prepared in step (4) is stuck on the double-sided tape. The test sample is cut with a utility knife and a ruler into a sample to be tested with a size of 80 mm and a width of 15 mm. (6) An electronic universal testing machine INSTRON3365 is turned on and the option of 1800 peeling test is selected to prepare for the test: a free end of the sample is folded in half by 180°, the adhesive surface is peeled off from a test board for about 25 mm, the free end of the sample and the test board are clamped on upper and lower holders respectively, and the sensor is just unstressed. During clamping, the peeled surface is consistent with the force line of a tensile machine. (7) A test button on a control panel is pressed to start the test. After the test stroke is completed, an upper chuck of the tensile machine will return to its position. When the upper chuck returns to its position, the test board will be taken out from a lower chuck. At least three data are taken for each test, and the adhesion of the sample is expressed as a mean value.

In some embodiments, the adhesion of the first resin to the conductive layer is within a range of 2.0N/15 mm to 5.5N/15 mm, and the adhesion of the second resin to the conductive layer is within a range of 3.5N/15 mm to 7.5N %15 mm. In some embodiments, the adhesion of the first resin to the conductive layer is within a range of 2.5N/15 mm to 5.2N/15 mm, and the adhesion of the second resin to the conductive layer is within a range of 4.0N/15 mm to 6.0N/15 mm. In some embodiments, the adhesion of the first resin to the conductive layer is within a range of 4.0N/15 mm to 5.0N/15 mm, and the adhesion of the second resin to the conductive layer is within a range of 4.0N/15 mm to 5.5N/15 mm. For example, in some embodiments, the adhesion of the first resin to the conductive layer can be 2.0N/15 mm, 2.2N/15 mm, 2.4N/15 mm, 2.5N/15 mm, 2.8N/15 mm, 3.0N/15 mm, 3.5N/15 mm, 4.0N/15 mm, 4.3N/15 mm, 4.5N/15 mm, 4.9N/15 mm, 5.0N/15 mm, or 5.5N/15 mm, and the adhesion of the second resin to the conductive layer can be 3.5N/15 mm, 3.8N/15 mm, 4.0N/15 mm, 4.1N/15 mm, 4.2N/15 mm, 4.3N/15 mm, 4.5N/15 mm, 4.7N/15 mm, 4.8N/15 mm, 4.9N/15 mm, 5.0N/15 mm, 5.5N/15 mm, 6.0N/15 mm, 7.0N/15 mm or 7.5N/15 mm. When the adhesions of the first resin and the second resin to the conductive layer respectively meet the above ranges, it is beneficial to enhancing the interface adhesion of the composite current collector and the falling-off phenomenon of the conductive layer can be reduced or avoided, thereby ensuring that the current collector has good structural stability and working stability so that the current collector has a long service life.

The adhesion of the resin to the conductive layer can be determined by methods known in the art. As an example, the exemplary test method of the adhesion of the resin to the conductive layer is as follows: (1) Sample preparation: resin (such as the first resin or the second resin) is prepared into a thin film with a thickness of about 5 um in a cuboid mold made of release paper, and a metal layer with a thickness of about 0.5 um is deposited on this thin film. (2) An EAA hot-melt adhesive with a thickness of about 80 μm and a 12 μm PET film are hot pressed by a hot press LCP200-A2008N for 30 s at 85° C., 0.7 MPa. (3) The above-mentioned sample with a deposited metal layer is cut into a 2 cm×10 cm sample strip and wiped clean with dust-free paper moistened with absolute ethanol. (4) Release paper on the surface layer of the hot-pressed EAA is peeled off, and the adhesive surface is aligned with the cut sample with a deposited metal layer and then hot pressed by the hot press for 45 s at 85° C., 0.7 MPa. (5) A double-sided tape is stuck on a steel plate with a length of 125±1 mm, a width of 50±1 mm, and a thickness of 1.5-2 mm and release paper is then peeled off, and a base film side of the composite sample prepared in step (4) is stuck on the double-sided tape. The test sample is cut with a utility knife and a ruler into a sample to be tested which is 80 mm long and 15 mm wide. (6) An electronic universal testing machine INSTRON3365 is turned on and the option of 180° peeling test is selected to prepare for the test: a free end of the sample is folded in half by 180°, the adhesive surface is peeled off from a test board for about 25 mm, the free end of the sample and the test board are clamped on upper and lower holders respectively, and the sensor is just unstressed. During clamping, the peeled surface is consistent with the force line of a tensile machine. (7) A test button on a control panel is pressed to start the test. After the test stroke is completed, an upper chuck of the tensile machine will return to its position. When the upper chuck returns to its position, the test board will be taken out from a lower chuck. At least three data are taken for each test, and the adhesion of the sample is expressed as a mean value.

In some embodiments, the difference between the swelling ratio of the second resin in the electrolyte and the swelling ratio of the first resin in the electrolyte is greater than or equal to 3% by mass, further greater than or equal to 14% by mass, based on soaking in the electrolyte with a temperature of 85° C. for 72 h, i.e., (the swelling ratio of the second resin in electrolyte—the swelling ratio of the first resin in electrolyte)≥3% by mass. Further, the difference between the swelling ratio of the second resin in the electrolyte and the swelling ratio of the first resin in the electrolyte is greater than or equal to 5% by mass. Furthermore, the difference between the swelling ratio of the second resin in the electrolyte and the swelling ratio of the first resin in the electrolyte is greater than or equal to 15% by mass. The first resin and the second resin not only have different adhesion to the conductive layer, but also have different adhesion to the organic support layer, and the swelling ratios of the first resin and the second resin in the electrolyte are also different. The swelling ratio of the first resin in the electrolyte is less than that of the second resin in the electrolyte. In this way, it is more conducive to enhancing the interface adhesion of the current collector and improving electrolyte resistance, thereby ensuring that the current collector has good structural stability and working stability.

In some embodiments, based on soaking in the electrolyte with a temperature of 85° C. for 72 h, the swelling ratio of the first resin in the electrolyte is within a range of 4% by mass to 8% by mass and the swelling ratio of the second resin in the electrolyte is within a range of 7% by mass to 33% by mass. In some embodiments, based on soaking in the electrolyte with a temperature of 85° C. for 72 h, the swelling ratio of the first resin in the electrolyte is 4% by mass, 5% by mass, 6% by mass, 7% by mass, 8% by mass, 10% by mass, 15% by mass, 16% by mass or 18% by mass, the swelling ratio of the second resin in the electrolyte is 7% by mass, 12% by mass, 16% by mass, 18% by mass, 20% by mass, 25% by mass, 30% by mass, 31% by mass, 32% by mass or 33% by mass, and it is satisfied that the difference between the swelling ratio of the second resin in the electrolyte and the swelling ratio of the first resin in the electrolyte is greater than or equal to 3% by mass; further, the difference between the swelling ratio of the second resin in the electrolyte and the swelling ratio of the first resin in the electrolyte is greater than or equal to 14% by mass.

The swelling ratio of the resin in the electrolyte can be tested by methods known in the art. As an example, the test method of the swelling ratio of the resin in the electrolyte is as follows. (1) The resin (such as the first resin or the second resin) is made into a film and then completely dried. (2) The film is weighed to obtain an initial weight, denoted as W1. (3) The film is put into a 15 cm*15 cm pocket (bag), 50 ml of 1 mol/L lithium hexafluorophosphate electrolyte is then added and the pocket is then sealed with a heat sealer. (4) The above sealed pocket is placed in an oven with a temperature of 85° C. and then taken out after 72 h; the film is taken out of the pocket, the electrolyte on the surface of the film is blotted with dust-free paper, the film is then weighed and the obtained weight is denoted as W2. The swelling ratio of the resin in the electrolyte is calculated according to the formula: (W2−W1)/W1. It should be noted that during the test, at least three films of the same resin are prepared, and the same film is weighed at least three times to reduce accidental errors and improve the accuracy of the test.

In some embodiments, a solubility parameter of the intermediate coating ranges from 7.5 to 12. In some embodiments, the solubility parameter of the intermediate coating ranges from 8 to 11. In some embodiments, the solubility parameter of the intermediate coating can be 7.5, 8, 8.2, 8.6, 9, 9.5, 9.8, 10, 10.5, 11, 11.5 or 12. In the above-mentioned intermediate coating, the adhesions of the first resin and the second resin are different, the adhesion of the first resin is less than the adhesion of the second resin, the swelling ratios of the first resin and the second resin in the electrolyte are also different, the swelling ratio of the first resin in the electrolyte is less than the swelling ratio of the second resin in the electrolyte, and the solubility parameters of the first resin and the second resin can be the same or similar. Therefore, the advantages of various resins can be given a full play, which is more conducive to enhancing the interface adhesion of the current collector and improving the electrolyte resistance. When the solubility parameter of the intermediate coating satisfies the above ranges, it is conducive to enabling the electrochemical apparatus to have high electrochemical performance, such as longer cycle life.

The solubility parameter of the intermediate coating can be tested by methods known in the art. As an example, the test method of the solubility parameter of the intermediate coating can be tested by turbidity titration, which specifically includes the following steps: (1) About 0.2 g of a polymer sample is weighed and dissolved in 25 ml of chloroform, and 10 ml of the solution is pipetted into a test tube. The polymer solution is first titrated with n-pentane until precipitate appears and the test tube is shaken to dissolve the precipitate. N-pentane is added again and it is gradually difficult to dissolve the precipitate by shaking, titration is terminated until the precipitate that appears is just unable to dissolve, and the volume of n-pentane used (Vₙ₋ₚₑₜₐₙₑ) is recorded. (2) Referring to the experimental process of step (1), n-pentane is replaced with methanol, and the volume of methanol used (Vₘₑₜₕₐₙₒₗ) is record. (3) The solubility parameters of the n-pentane/chloroform mixed solvent and the methanol/chloroform mixed solvent are calculated according to the formula: δ_{mixed}=δ₁X1+δ₂X2, where S represents the solubility parameter of the single-component substance, and X represents the volume fraction of the single-component substance. (4) The solubility parameter of the coating is calculated according to the formula δ_{coating}=(δ_{n-pentane-chloroform}+δ_{methanol-chloroform})/2.

In some embodiments, a thermal expansion coefficient of the intermediate coating ranges from 50×10⁻⁶ K⁻¹ to 80×10₋₆ K⁻¹. In some embodiments, the thermal expansion coefficient of the intermediate coating ranges from 55×10⁻³ K⁻¹ to 75×10⁻⁶ K⁻¹. In some embodiments, the thermal expansion coefficient of the intermediate coating can be 50×10⁻⁶ K⁻¹, 51×10⁻⁶ K⁻¹, 53×10⁻⁶ K⁻¹, 55×10⁻⁶ K⁻¹, 57×10⁻⁶ K⁻¹, 57.6×10⁻⁶ K⁻¹, 59×10⁻⁶ K⁻¹, 60×10⁻⁶ K⁻¹, 65×10⁻⁶ K⁻¹, 69×10⁻⁶ K⁻¹, 70×10⁻⁶ K⁻¹, 75×10⁻⁶ K⁻¹ or 80×10⁻⁶ K⁻¹. In the above-mentioned intermediate coating, the thermal expansion coefficients of the first resin and the second resin may be the same or similar.

The above-mentioned polymer intermediate coating uses two or more resin systems which are similar in solubility parameter and thermal expansion coefficient, but are quite different in adhesion and electrolyte resistance. By adjusting the segment composition and the resin ratio, the advantages of each resin system can be given a full play, and the composite resin system constructed can be used to enhance the interface bonding of the composite current collector and improve the electrolyte swelling resistance.

In some embodiments, the mass ratio of the first resin to the second resin is within a range of 2:98 to 98:2. In some embodiments, the mass ratio of the first resin to the second resin is within a range of 5:95 to 95:5. In some embodiments, the mass ratio of the first resin to the second resin is within a range of 10:90 to 90:10. In some embodiments, the mass ratio of the first resin to the second resin is within a range of 15:85 to 85:15. In some embodiments, the mass ratio of the first resin to the second resin can be 2:98, 3:97, 5:95, 8:92, 10:90, 12:88, 15:85, 20:80, 30:70, 40:60, 50:50, 60:40, 70:30, 80:20, 85:15, 90:10, 95:5 or 98:2. When the mass ratio of the first resin to the second resin satisfies the above range, the adhesion and electrolyte resistance can be balanced, so that the auxiliary resin can show continuity in the main resin and the adhesive layer can have proper flexibility.

In some embodiments, the first resin includes at least one of polyacrylic resin (PAA), modified polyolefin resin (MPO) and organic silicone resin (OS), the second resin includes at least one of polyacrylate (PEA), polyurethane (PU), unsaturated polyester (UP), phenolic resin (PF), ethylene-acrylic acid copolymer (EAA), ethylene-vinyl acetate copolymer (EVA) and epoxy resin (EPO), and the first resin and the second resin are not both epoxy resin (EPO) at the same time. Further, in some embodiments, the first resin further includes polyethylene-grafted maleic anhydride resin. Relatively speaking, by selecting the above-mentioned resins as the first resin, the first resin has good the electrolyte resistance and low adhesion, and by selecting the above-mentioned resins as the second resin, the second resin has high adhesion but relatively poor electrolyte resistance.

In some embodiments, the resin composition includes two or more of polyurethane (PU), epoxy resin (EPO), polyacrylate (PEA), phenolic resin (PF), unsaturated polyester (UP), modified polyolefin resin (MPO), organic silicone resin (OS), ethylene-acrylic acid copolymer (EAA), ethylene-vinyl acetate copolymer (EVA), polyacrylic acid resin (PAA) and polyethylene-grafted maleic anhydride resin.

In some embodiments, the resin composition includes, but is not limited to, any combination of polyurethane and epoxy resin; polyurethane and modified polyolefin resin; epoxy resin and modified polyolefin resin; polyurethane and organic silicone resin; polyacrylate and modified polyolefin resin; polyurethane and phenolic resin; polyurethane and polyacrylic resin; polyurethane, epoxy resin and organic silicone resin; and polyurethane, epoxy resin and modified polyolefin resin.

In some embodiments, when the first resin is organic silicone resin, the second resin is polyurethane, or the second resin is epoxy resin, or the second resin is polyurethane and epoxy resin.

In some embodiments, when the first resin is a modified polyolefin resin, the second resin is polyurethane, or the second resin is epoxy resin, or the second resin is epoxy resin and polyurethane.

Among the various resins mentioned above, the epoxy resin includes bisphenol A epoxy resin, the polyurethane includes hydroxyl-curable polyurethane, the organic silicone resin includes phenyl silicone resin, and the modified polyolefin resin includes carboxylated polyolefin.

In some embodiments, the first resin is a modified polyolefin resin, the second resin includes polyurethane and epoxy resin, and the mass percent of the second resin in the resin composition is within a range of 2% to 30%. That is, when the resin composition is selected from polyurethane, epoxy resin and modified polyolefin resin, the mass percent of polyurethane and epoxy resin in the resin composition is within a range of 2% to 30%. In this way, it is beneficial to taking full advantage of the high electrolyte resistance of MPO.

In the above-mentioned intermediate coating, the proportioning principle of the composite resin is mainly to balance the bonding of the coating (having high fastness with the metal layer and the polymer film layer) and electrolyte resistance, while taking into account the problems about the continuity of the small proportion of auxiliary substances doped in the main substance, as well as the processability of the composite resin (viscosity and fluidity of the adhesive solution), the buffering effect and bending resistance of the adhesive layer (hardness and flexibility of the adhesive layer and the like).

It should be noted that in a case where the role of a certain component in the composite system needs to be highlighted, its proportion can be increased appropriately, but the component must be dissolved in the same or similar solvent, there will be no gel or sudden increase in viscosity during mixing, and the composite adhesive solution will exist stably throughout the processing process.

In some embodiments, the thickness of the intermediate coating is within a range of 0.2 μm to 2 μm. In some embodiments, the thickness of the intermediate coating is within a range of 0.2 μm to 1.5 μm. In some embodiments, the thickness of the intermediate coating is within a range of 0.5 μm to 1 μm. In some embodiments, the thickness of the intermediate coating can be 0.2 μm, 0.5 μm, 0.8 μm, 1 μm, 1.2 μm, 1.5 μm, 1.8 μm or 2 μm

The intermediate coating with an appropriate thickness can ensure that the current collector has good electrical conductivity and current collection performance so that the battery has good electrochemical performance, and it also can cause the current collector to have a low weight so that the battery has a high gravimetric energy density. In addition, the intermediate coating with an appropriate thickness also helps to reduce or avoid damage during processing, so that the current collector has good mechanical stability and working stability.

In some embodiments, the organic support layer includes an organic polymer including, but not limited to, at least one of polyethylene (PE), polypropylene (PP), polyethylene terephthalate (PET), polybutylene terephthalate, polyethylene naphthalate (PEN), polyparaphenylene terephthalamide (PPTA), polyimide (PI), polycarbonate (PC), polyether ether ketone (PEEK), polyoxymethylene (POM), poly-p-phenylene sulfide (PPS), poly-p-phenylene oxide (PPO), polyvinyl chloride (PVC), polyamide (PA), polytetrafluoroethylene (PTFE), polyvinylidene fluoride, and polystyrene. In some embodiments, the organic polymer may be, for example, polyethylene (PE), polyethylene terephthalate (PET), or polycarbonate (PC).

In some embodiments, the thickness of the organic support layer is within a range of 2 μm to 36 μm. In some embodiments, the thickness of the organic support layer is within a range of 4 μm to 36 μm. In some embodiments, the thickness of the organic support layer is within a range of 6 μm to 30 μm. In some embodiments, the thickness of the organic support layer can be 2 μm, 4 μm, 5 μm, 6 μm, 8 μm, 10 μm, 12 μm, 15 μm, 20 μm, 25 μm, 30 μm, 32 μm or 36 μm. The organic support layer with an appropriate thickness not only plays a supporting role effectively, but also helps the battery to have a high gravimetric energy density.

In some embodiments, the material of the conductive layer includes, but is not limited to, at least one of a metal conductive material and a carbon-based conductive material. The metal conductive material includes at least one of aluminum, copper, nickel, iron, titanium, silver, gold, cobalt, chromium, molybdenum, and tungsten, and the carbon-based conductive material includes at least one of graphite, acetylene black, graphene and carbon nanotubes. In some embodiments, the material of the conductive layer may be, for example, aluminum, copper, nickel, a copper alloy, a nickel alloy, an aluminum alloy or the like.

In some embodiments, the thickness of the conductive layer is within a range of 100 nm to 5000 nm. In some embodiments, the thickness of the conductive layer is within a range of 500 nm to 4000 nm. In some embodiments, the thickness of the conductive layer is within a range of 1000 nm to 3000 nm. In some embodiments, the thickness of the conductive layer can be 100 nm, 200 nm, 500 nm, 800 nm, 1000 nm, 1500 nm, 2000 nm, 2500 nm, 3000 nm, 4000 nm or 5000 nm. The conductive layer with an appropriate thickness can ensure that the current collector has good electrical conductivity and current collection performance so that the battery has good electrochemical performance, and it also can cause the current collector to have a low weight so that the battery has a high gravimetric energy density.

In some embodiments, the conductive layer is a vapor deposition layer. The conductive layer can be formed on the intermediate coating by vapor deposition, chemical plating, electroplating or mechanical rolling, among which vapor deposition is preferred. In this way, a tighter adhesion between the conductive layer, the intermediate coating layer and the organic support layer can be achieved.

The vapor deposition method is preferably a physical vapor deposition method. The physical vapor deposition method is preferably at least one of evaporation and sputtering; the evaporation is preferably at least one of vacuum evaporation, thermal evaporation and electron beam evaporation, and the sputtering is preferably magnetron sputtering.

As an example, the conductive layer may be formed by vacuum evaporation. The formation of the conductive layer may include: placing in a vacuum coating chamber the organic support layer coated with the intermediate coating, melting and evaporating a high-purity metal wire in a metal evaporation chamber at a high temperature of 1200° C.-1500° C., and finally depositing the evaporated metal on the intermediate coating through a cooling system in the vacuum plating chamber to form the conductive layer.

FIG. 2 schematically shows a current collector as another example. Referring to FIG. 2, in some embodiments, the conductive layer includes a first conductive layer 101 and a second conductive layer 102, and the intermediate coating includes a first intermediate coating 201 and a second intermediate coating 202,
the first conductive layer 101, the first intermediate coating 201, the organic support layer 30, the second intermediate coating 202, and the second conductive layer 102 are sequentially stacked.

It can be understood that in some cases, an intermediate coating and a conductive layer can be disposed on one side surface of the organic support layer. In other cases, an intermediate coating and a conductive layer may also be disposed on both side surfaces of the organic support layer. This may be selected and set according to actual needs.

Electrochemical Apparatus

According to a second aspect of the present application, provided is an electrochemical apparatus, including a positive electrode, a negative electrode and an electrolyte, wherein the positive electrode and/or the negative electrode includes the current collector as described in the first aspect of the present application.

The current collector of the present application can be used in the preparation of a positive electrode/negative electrode. A mixture including a positive active material/negative active material and an adhesive is prepared into a slurry, applied to the current collector, and dried to obtain a positive electrode/negative electrode. The current collector of the present application is particularly preferable as a current collector of a positive electrode of a secondary battery.

In some embodiments, the positive electrode includes a positive electrode current collector and a positive active material layer applied to the surface of the positive electrode current collector. Further, the positive active material layer includes a positive active material, a conductive additive and an adhesive. The positive electrode current collector is the current collector according to any of the above-mentioned embodiments of the present application.

In some embodiments, the positive active material layer may include a lithium-transition metal composite oxide, wherein the transition metal may be one or more of Mn, Fe, Ni, Co, Cr, Ti, Zn, V, Al, Zr, Ce, and Mg. The lithium-transition metal composite oxide can also be doped with an element with high electronegativity, such as one or more of S, F, Cl and I. In this way, the positive active material has high structural stability and electrochemical performance. As an example, the lithium-transition metal composite oxide may be one or more of LiMn₂O₄, LiNiO₂, LiCoO₂, LiNi_{1-y}Co_{y}O₂(0<y<1), LiNiₐCo_{b}Al_{1-a-b-}O₂(0<a<1, 0<b<1, 0<a+b<1), LiMn₁₋ₘ₋ₙNiₘCoₙO₂(0<m<1, 0<n<1, 0<m+n<1), or LiMPO₄(M can be one or more of Fe, Mn and Co) and Li₃V₂(PO₄)₃.

In some embodiments, as an example, the conductive additive may be one or more of graphite, superconducting carbon, acetylene black, carbon black, Ketjen black, carbon dots, carbon nanotubes, graphene or carbon nanofiber.

In some embodiments, as an example, the adhesive may be one or more of styrene-butadiene rubber (SBR), water-based acrylic resin (water-based acrylicesin), carboxymethyl cellulose (CMC), polyvinylidene fluoride (PVDF), polytetrafluoroethylene (PTFE), ethylene-vinyl acetate copolymer (EVA), polyvinyl alcohol (PVA) and polyvinyl butyral (PVB).

The positive electrode can be prepared by dispersing a positive active material, an optional conductive additive and an adhesive in a solvent (e.g., N-methylpyrrolidone, NMP) to form a uniform positive electrode slurry, applying the positive electrode slurry to the positive electrode current collector, and carrying out drying and other processes.

In some embodiments, the negative electrode may include a negative electrode current collector and a negative active material layer disposed on the negative electrode current collector. The negative electrode current collector is the current collector according to any of the above-mentioned embodiments of the present application. Alternatively, the negative electrode current collector can be a metal foil, a carbon-coated metal foil and a porous metal foil. As an example, the negative electrode current collector may include one or more of copper, a copper alloy, nickel, a nickel alloy, iron, an iron alloy, titanium, a titanium alloy, silver, and a silver alloy.

In some embodiments, the negative active material layer may use at least one of lithium metal, natural graphite, artificial graphite, mesocarbon microbeads (MCMBs), hard carbon, soft carbon, silicon, a silicon-carbon composite, SiO, a Li—Sn alloy, a Li—Sn—O alloy, Sn, SnO, SnO₂, lithium titanate of spinel structure, and a Li—Al alloy.

Optionally, the negative active material layer may further include an adhesive. As an example, the adhesive may be one or more of styrene-butadiene rubber (SBR), water-based acrylic resin (water-based acrylicesin), carboxymethyl cellulose (CMC), polyvinylidene fluoride (PVDF), polytetrafluoroethylene (PTFE), ethylene-vinyl acetate copolymer (EVA), polyvinyl alcohol (PVA) and polyvinyl butyral (PVB).

Optionally, the negative active material layer may further include a conductive additive. As an example, the conductive agent may be one or more of graphite, superconducting carbon, acetylene black, carbon black, Ketjen black, carbon dots, carbon nanotubes, graphene or carbon nanofiber.

The negative electrode can be prepared by dispersing a negative active material, an optional conductive additive and an adhesive in a solvent (e.g., NMP or deionized water) to form a uniform negative electrode slurry, applying the negative electrode slurry to the negative electrode current collector, and carrying out drying and other processes.

As an improvement, the electrolyte includes an organic solvent, a lithium salt and an additive.

As an improvement, the organic solvent is one or more of conventional organic solvents such as a cyclic carbonate, a linear carbonate, a carboxylate and the like. Specifically, the organic solvent may be, but not limited to, one or more of the following organic solvents: ethylene carbonate (EC), propylene carbonate (PC), diethyl carbonate (DEC), ethyl methyl carbonate (EMC), dimethyl carbonate (DMC), fluoroethylene carbonate (FEC), vinylene carbonate (VC), propylene carbonate, dipropyl carbonate, methyl formate, ethyl formate, ethyl propionate (EP), propyl propionate, methyl butyrate, and ethyl acetate.

As an improvement, the lithium salt is at least one of an inorganic lithium salt and an organic lithium salt. The inorganic lithium salt is at least one of lithium hexafluorophosphate (LiPF₆), lithium tetrafluoroborate (LiBF₄), lithium hexafluoroarsenate (LiAsF₆) and lithium perchlorate (LiCIO₄). The organic lithium salt is at least one of lithium bisoxalate borate (LiB(C₂O₄)₂, abbreviated as LiBOB), lithium bisfluorosulfonyl imide (LiFSI) and lithium bistrifluoromethanesulfonyl imide (LiTFSI).

As an improvement, the additive is one or more of fluorine-containing, sulfur-containing, and unsaturated double bond-containing compounds. Specifically, the additive may be, but not limited to, one or more of the following substances: fluoroethylene carbonate, vinyl sulfite, propane sultone, N-methylpyrrolidone, N-methylformamide, N-methylacetamide, acetonitrile, acrylonitrile, T-butyrolactone, and methyl sulfide.

In order to prevent a short circuit, a separator is usually disposed between the positive electrode and the negative electrode. In this case, the electrolyte is usually used by permeating the separator.

The present application has no particular limitation on the material and shape of the separator, as long as the effect of the present application is not significantly impaired. The separator may be resin, glass fiber, inorganic matter, etc. made of a material stable to the electrolyte.

In the electrochemical apparatus of the present application, the material of the separator includes, but is not limited to, a polymer separator, which may be, for example, one of polyethylene, polypropylene and ethylene-propylene copolymers.

The electrochemical apparatus of the present application includes any device that undergoes an electrochemical reaction, and its specific examples include all kinds of primary batteries, secondary batteries, fuel cells, solar cells, or capacitors. Particularly, the electrochemical apparatus is a lithium secondary battery, including a lithium metal secondary battery, a lithium ion secondary battery, a lithium polymer secondary battery, or a lithium ion polymer secondary battery.

[Electronic Device]

According to a third aspect of the present application, provided is an electronic device, including the electrochemical apparatus as described in the second aspect of the present application.

The application of the electrochemical apparatus of the present application is not particularly limited, and the electrochemical apparatus can be used in any electronic device known in the prior art. The electrochemical apparatus may serve as a power supply for the electronic device and may also serve as an energy storage unit for the electronic device.

In some embodiments, the electrochemical apparatus of the present application can be used in, but not limited to, a notebook computer, a pen-input computer, a mobile computer, an e-book players, a cellular phone, a portable fax machine, a portable copier, a portable printer, a stereo headphone, a video recorder, an LCD TV set, a portable cleaner, a portable CD player, a mini-disk, a transceiver, an electronic diary, a calculator, a memory card, a portable recorder, a radio, a backup power supply, a motor, an automobile, a motorcycle, an electric bike, a bicycle, a lighting appliance, a toy, a game console, a clock, an electric tool, a flashlight, a camera, a large battery for household use, and a lithium-ion capacitor.

As an example, the electronic device may be a cell phone, a tablet computer, a notebook computer, and the like. The electronic device is generally required to be light and thin, and may use a secondary battery as a power supply.

Taking a lithium-ion battery as example below, the preparation of the lithium-ion battery is illustrated in conjunction with specific embodiments. Those skilled in the art will understand that preparation methods described in the present application are only examples, and any other suitable preparation methods are within the scope of the present application.

The performance evaluation of the examples and comparative examples of the lithium-ion battery according to the present application will be described below. All parts, percents or ratios reported in the following examples are by mass unless otherwise stated. In the following examples and comparative examples, the reagents, materials and instruments used are commercially available unless otherwise specified.

### Embodiments and Comparative Embodiments

Preparation of Current Collector

(1) Preparation of Current Collector 1

Corona treatment was performed on a PET film of the organic support layer. Carboxylated polyolefin and carboxy-curable polyurethane were well mixed at a mass ratio of 30:70, then applied to the surface of the PET film, and dried at 120° C. to evaporate the solvent. Next, the coated PET film (including the organic support layer and the intermediate coating) was placed in a vacuum chamber of a crucible boat type vacuum evaporation aluminum plating machine, the vacuum chamber was sealed, the air pressure of the vacuum aluminum plating machine was pumped to 10⁻¹ Pa, the temperature of the crucible boat was adjusted to 1200° C.-1500° C., and aluminum plating was then carried out. After the thickness of A1 reached 1000 nm, the aluminum plating was stopped, and a conductive layer was formed on the surface of the intermediate coating, and then the current collector 1 was obtained.

(2) Preparation of Current Collectors 2-20

According to the above-mentioned preparation method of the current collector 1, the current collectors 2-20 were prepared. The present application also prepared the current collectors 2-20. However, the current collectors are different in the types and ratios of the first resin and the second resin, or in the thickness of the intermediate coating, or in the thickness or composition of the organic support layer, or in the thickness of the conductive layer.

The relevant performance parameters of the current collectors 1-20 are shown in Table 1 and Table 2 below.

(3) Preparation of Current Collectors 1 #-2 #

PET film subjected to corona treatment was placed in a vacuum chamber of a crucible boat type vacuum evaporation aluminum plating machine, the vacuum chamber was sealed, the air pressure of the vacuum aluminum plating machine was pumped to 10-3 Pa, the temperature of the crucible boat was adjusted to 1200° C.-1500° C., and aluminum plating was then carried out. After the thickness of A1 reached 100 nm, the aluminum plating was stopped, and then the comparative current collector 1 #was obtained.

According to the above-mentioned preparation method of the current collector 1 #, the present application also prepared the current collector 2 #. However, the current collectors were different in the thickness of the organic support layer and the thickness of the conductive layer.

(4) Preparation of Current Collectors 3 #-8 #

A PET film subjected to corona treatment was coated with bisphenol A epoxy resin and then placed in a vacuum chamber of a crucible boat type vacuum evaporation aluminum plating machine, the vacuum chamber was sealed, the air pressure of the vacuum aluminum plating machine was pumped to 10-3 Pa, the temperature of the crucible boat was adjusted to 1200° C.-1500° C. and aluminum plating was then carried out. After the thickness of A1 reached 1000 nm, the aluminum plating was stopped, and then the comparative current collector 3 #was obtained.

According to the above-mentioned preparation method of the current collector 3 #, the present application also prepared the current collectors 4 #-8 #. However, the current collectors were different in the types of resins or the ratios of resins.

The relevant performance parameters of the current collectors 1 #-8 #are shown in Table 1 and Table 2 below. The adhesion of the resin to the organic support layer, the adhesion of the resin to the conductive layer, the swelling ratio of the resin in the electrolyte, and the solubility parameter of the intermediate coating were tested by the test methods described above.

In Table 1, the mass ratio represents the mass ratio of the first resin to the second resin; the first adhesion-30 represents the adhesion of the first resin to the organic support layer, N/15 mm; the second adhesion-30 represents the adhesion of the second resin to the organic support layer, N/15 mm; the first adhesion-10 represents the adhesion of the first resin to the conductive layer, N/15 mm; and the second adhesion-10 represents the adhesion of the second resin to the conductive layer, N/15 mm.

TABLE 1

| | | | Mass | First | Second | First | Second |
|---|---|---|---|---|---|---|---|
| Description | First resin | Second resin | ratio | adhesion-30 | adhesion-30 | adhesion-10 | adhesion-10 |
| Current | Carboxylated | Carboxy-curable | 30:70 | 2.3 | 4.5 | 4.3 | 4.9 |
| collector 1 | polyolefin | polyurethane | | | | | |
| Current | Carboxylated | Carboxy-curable | 70:30 | 2.3 | 4.5 | 4.3 | 4.9 |
| collector 2 | polyolefin | polyurethane | | | | | |
| Current | Carboxylated | Carboxy-curable | 70:30 | 2.3 | 4.5 | 4.3 | 4.9 |
| collector 3 | polyolefin | polyurethane | | | | | |
| Current | Carboxylated | Carboxy-curable | 70:30 | 2.3 | 4.5 | 4.3 | 4.9 |
| collector 4 | polyolefin | polyurethane | | | | | |
| Current | Carboxylated | Carboxy-curable | 70:30 | 2.3 | 4.5 | 4.3 | 4.9 |
| collector 5 | polyolefin | polyurethane | | | | | |
| Current | Carboxylated | Bisphenol A | 70:30 | 2.3 | 4.8 | 4.5 | 4.9 |
| collector 6 | polyolefin | epoxy resin | | | | | |
| Current | Carboxylated | Bisphenol A | 90:10 | 2.3 | 4.8 | 4.5 | 4.9 |
| collector 7 | polyolefin | epoxy resin | | | | | |
| Current | Carboxylated | Bisphenol A | 10:90 | 2.3 | 4.5 | 4.0 | 4.9 |
| collector 8 | polyolefin | epoxy resin | | | | | |
| Current | Phenyl | Bisphenol A | 70:30 | 2.1 | 4.8 | 4.0 | 4.5 |
| collector 9 | silicone resin | epoxy resin | | | | | |
| Current | Phenyl | Bisphenol A | 90:10 | 2.1 | 4.8 | 4.0 | 4.5 |
| collector 10 | silicone resin | epoxy resin | | | | | |
| Current | Phenyl | Bisphenol A | 10:90 | 2.1 | 4.5 | 4.0 | 4.1 |
| collector 11 | silicone resin | epoxy resin | | | | | |
| Current | Phenyl | Carboxy-curable | 70:30 | 2.1 | 4.5 | 4.0 | 4.3 |
| collector 12 | silicone resin | polyurethane | | | | | |
| Current | Phenyl | Carboxy-curable | 90:10 | 2.1 | 4.5 | 4.0 | 4.3 |
| collector 13 | silicone resin | polyurethane | | | | | |
| Current | Phenyl | Carboxy-curable | 10:90 | 2.1 | 4.5 | 4.0 | 4.3 |
| collector 14 | silicone resin | polyurethane | | | | | |
| Current | Phenyl | Bisphenol A | 90:10 | 2.1 | 4.7 | 4.0 | 4.4 |
| collector 15 | silicone resin | epoxy resin: | | | | | |
| | | 50 wt %; | | | | | |
| | | Carboxy-curable | | | | | |
| | | polyurethane: | | | | | |
| | | 50 Wt % | | | | | |
| Current | Phenyl | Bisphenol A | 80:20 | 2.1 | 4.7 | 4.0 | 4.4 |
| collector 16 | silicone resin | epoxy resin: | | | | | |
| | | 50 wt %; | | | | | |
| | | Carboxy-curable | | | | | |
| | | polyurethane: | | | | | |
| | | 50 Wt% | | | | | |
| Current | Phenyl | Bisphenol A | 70:30 | 2.1 | 4.7 | 4.0 | 4.4 |
| collector 17 | silicone resin | epoxy resin: | | | | | |
| | | 50 wt %; | | | | | |
| | | Carboxy-curable | | | | | |
| | | polyurethane: | | | | | |
| | | 50 Wt% | | | | | |
| Current | Carboxylated | Bisphenol A | 90:10 | 2.3 | 4.7 | 4.3 | 4.4 |
| collector 18 | polyolefin | epoxy resin: | | | | | |
| | | 50 wt%; | | | | | |
| | | Carboxy-curable | | | | | |
| | | polyurethane: | | | | | |
| | | 50 Wt % | | | | | |
| Current | Carboxylated | Bisphenol A | 80:20 | 2.3 | 4.7 | 4.3 | 4.4 |
| collector 19 | polyolefin | epoxy resin: | | | | | |
| | | 50 wt%; | | | | | |
| | | Carboxy-curable | | | | | |
| | | polyurethane: | | | | | |
| | | 50 Wt % | | | | | |
| Current | Carboxylated | Bisphenol A | 70:30 | 2.3 | 4.7 | 4.3 | 4.4 |
| collector 20 | polyolefin | epoxy resin: | | | | | |
| | | 50 wt %; | | | | | |
| | | Carboxy-curable | | | | | |
| | | polyurethane: | | | | | |
| | | 50 Wt % | | | | | |
| Current | / | / | / | / | / | / | / |
| collector 1# | | | | | | | |
| Current | / | / | / | / | / | / | / |
| collector 2# | | | | | | | |
| Current | / | Bisphenol A | 0:100 | / | 4.8 | / | 4.5 |
| collector 3# | | epoxy resin | | | | | |
| Current | / | Carboxy-curable | 0:100 | / | 4.5 | / | 4.3 |
| collector 4# | | polyurethane | | | | | |
| Current | Carboxylated | / | 100:0 | 2.3 | / | 4.9 | / |
| collector 5# | polyolefin | | | | | | |
| Current | Phenyl | / | 0:100 | 2.1 | / | 4.0 | / |
| collector 6# | silicone resin | | | | | | |
| Current | Phenolic resin | Carboxy-curable | 70:30 | 4.8 | 4.3 | 4.5 | 4.5 |
| collector 7# | | polyurethane | | | | | |
| Current | Carboxylated | Phenyl silicone | 70:30 | 2.3 | 4.9 | 2.1 | 4.0 |
| collector 8# | polyolefin | resin | | | | | |

“/” in the table above means no data added or no data.

In Table 2, the swelling ratio 1 represents the swelling ratio of the first resin in the electrolyte, the swelling ratio 2 represents the swelling ratio of the second resin in the electrolyte, the solubility parameter 1 represents the solubility parameter of the first resin, the solubility parameter 2 represents the solubility parameter of the second resin, the thermal expansion coefficient 1 represents the thermal expansion coefficient of the first resin, and the thermal expansion coefficient 2 represents the thermal expansion coefficient of the second resin. The component of the organic support layer in current collector 3 is PEN, and the components of the organic support layers in other current collectors 1, 2, and 4-20 and current collectors 1 #to 8 #are all PET. The components of the conductive layers in current collectors 1-16 and 18-20 and current collectors 1 #and 3 #−8 #are all A1, and the components of the conductive layers in current collectors 17 and 2 #are both Cu.

TABLE 2

| | | | | | Thermal | Thermal | | Thickness | |
|---|---|---|---|---|---|---|---|---|---|
| | Swelling | Swelling | | | expansion | expansion | Thickness of | of organic | Thickness of |
| | ratio 1 | ratio 2 | Solubility | Solubility | coefficient 1 | coefficient 2 | intermediate | support | conductive |
| Description | (% by mass) | (% by mass) | parameter 1 | parameter 2 | (×10⁻⁶ K⁻¹) | (×10⁻⁶ K⁻¹) | coating (μm) | layer (μm) | layer (μm) |
| Current collector 1 | 4 | 33 | 8.6 | 10 | 69 | 57.6 | 1 | 6 | 1 |
| Current collector 2 | 4 | 33 | 8.6 | 10 | 69 | 57.6 | 1 | 6 | 1 |
| Current collector 3 | 4 | 33 | 8.6 | 10 | 69 | 57.6 | 1 | 6 | 1 |
| Current collector 4 | 4 | 33 | 8.6 | 10 | 69 | 57.6 | 1 | 36 | 1 |
| Current collector 5 | 18 | 33 | 8.6 | 10 | 69 | 57.6 | 1 | 2 | 1 |
| Current collector 6 | 4 | 18 | 8.6 | 9.8 | 69 | 55 | 1 | 6 | 1 |
| Current collector 7 | 4 | 18 | 8.6 | 9.8 | 69 | 55 | 1 | 6 | 1 |
| Current collector 8 | 4 | 18 | 8.6 | 9.8 | 69 | 55 | 2 | 6 | 1 |
| Current collector 9 | 7 | 18 | 9 | 9.8 | 51 | 55 | 0.2 | 6 | 1 |
| Current collector 10 | 7 | 18 | 9 | 9.8 | 51 | 55 | 0.5 | 6 | 1 |
| Current collector 11 | 7 | 18 | 9 | 9.8 | 51 | 55 | 0.5 | 6 | 5 |
| Current collector 12 | 7 | 18 | 9 | 10 | 51 | 57.6 | 0.5 | 6 | 0.1 |
| Current collector 13 | 7 | 18 | 9 | 10 | 51 | 57.6 | 0.5 | 6 | 1 |
| Current collector 14 | 7 | 18 | 9 | 10 | 51 | 57.6 | 0.5 | 6 | 1 |
| Current collector 15 | 7 | 26 | 9 | 9.9 | 51 | 56.3 | 0.5 | 6 | 1 |
| Current collector 16 | 7 | 26 | 9 | 9.9 | 51 | 56.3 | 0.5 | 6 | 1 |
| Current collector 17 | 7 | 26 | 9 | 9.9 | 51 | 56.3 | 0.5 | 4.5 | 0.5 |
| Current collector 18 | 4 | 26 | 8.6 | 9.9 | 69 | 56.3 | 0.5 | 6 | 1 |
| Current collector 19 | 4 | 26 | 8.6 | 9.9 | 69 | 56.3 | 0.5 | 6 | 1 |
| Current collector 20 | 4 | 26 | 8.6 | 9.9 | 69 | 56.3 | 0.5 | 6 | 1 |
| Current collector 1# | / | / | / | / | / | / | / | 6 | 1 |
| Current collector 2# | / | / | / | / | / | / | / | 4.5 | 0.5 |
| Current collector 36# | / | 18 | / | 9.8 | / | 55 | 0.5 | 6 | 1 |
| Current collector 4# | / | 33 | / | 10 | / | 57.6 | 0.5 | 6 | 1 |
| Current collector 5# | 4 | / | 8.6 | / | 69 | / | 0.5 | 6 | 1 |
| Current collector 6# | 7 | / | 9 | / | 51 | / | 0.5 | 6 | 1 |
| Current collector 7# | 18 | 33 | 9.8 | 10 | 55 | 57.6 | 1 | 6 | 1 |
| Current collector 8# | 4 | 7 | 8.6 | 9 | 69 | 51 | 1 | 6 | 1 |

“/” in the table above means no data added or no data.

Preparation of Lithium-Ion Battery

(1) Preparation of Positive Electrode

A positive active material nickel cobalt lithium manganate (NCM811), a conductive additive (Superp), and an adhesive polyvinylidene fluoride were mixed at a weight ratio of about 97:1.4:1.6, N-methylpyrrolidone (NMP) was then added, and the resulting mixture was stirred to be uniform under the action of a vacuum mixer to obtain a positive electrode slurry. The positive electrode slurry was applied to the positive electrode current collector uniformly. The coated positive electrode current collector was dried at about 85° C., and then cold pressed, cut and slit, and then dried in vacuum at about 850(C for about 4 h to obtain a positive electrode.

(2) Preparation of Negative Electrode

A negative active material artificial graphite, sodium carboxymethylcellulose (CMC) and an adhesive styrene-butadiene rubber (SBR) were mixed in deionized water at a mass ratio of about 97:1:2 and well stirred to obtain a negative electrode slurry. The negative electrode slurry was uniformly applied to the negative electrode current collector. The coated negative electrode current collector was dried at 85° C., then cold pressed, cut and slit, and then dried in vacuum at about 120° C. for 12 h to obtain a negative electrode.

(3) Preparation of Electrolyte

In the electrolyte, the concentration of lithium hexafluorophosphate was 1 mol/L, and the organic solvent was composed of ethylene carbonate, propylene carbonate, diethyl carbonate, ethyl propionate, fluoroethylene carbonate, and 1,3-propanesultone.

(4) Separator

PE base film+ceramic coating on one side+water-based vinylidene fluoride-hexafluoropropylene copolymer coating on both sides constituted the separator.

(5) Preparation of Lithium-Ion Battery

Tabs were welded to the above-mentioned positive electrode and negative electrode, the positive electrode and the negative electrode together with the separator were then wound into a battery cell, packaged with an aluminum-plastic film, dried in vacuum for 24 h to remove moisture, then injected with the above-mentioned electrolyte, and rested at a high temperature. The batteries were formed and sorted to obtain square soft-packed lithium-ion batteries which are 3.8 mm in thickness, 64 mm width, and 82 mm in height.

Embodiments 1-16 and 18-20: In the preparation process of the positive electrode, the above current collectors 1-16 and 18-20 were respectively used positive electrode current collectors, and corresponding lithium ion batteries B1-B16 and B18-B20 were obtained by the above-mentioned method. Embodiment 17: In the preparation process of the negative electrode, the above-mentioned current collector 17 was used as a negative electrode current collector, and a corresponding lithium-ion battery B17 was obtained by the above-mentioned method.

Comparative Embodiments 1 and 3-8: In the preparation process of the positive electrode, the above-mentioned current collectors 1 #and 3 #-8 #were respectively used as positive electrode current collectors, and the corresponding lithium ion batteries D1 and D3-D8 were obtained by the above method. Comparative Embodiment 2: In the preparation process of the negative electrode, the current collector 2 #was used as the negative electrode current collector, and a corresponding lithium-ion battery D2 was obtained by the above method.

Test Part

Lithium-ion batteries were subjected to electrolyte injection pass rate test:

The relevant test methods for the release of the battery after electrolyte injection include: injecting the electrolyte into the battery that is wound and top-side sealed according to the electrolyte retention coefficient of 0.0015 g/mAh, then resting the battery still in an oven at a high temperature of 80° C. for 16 h, taking the battery out and cooling the battery down to room temperature, disassembling the battery and observing the damage of the electrode plate.

The performance test results of Embodiments and Comparative Embodiments are shown in Table 3.

In Table 3, the weight percent of the current collector refers to the percent by which the weight of the current collector of the present application increases ⬆ or decreases ⬇ relative to the weights of the conventional current collectors, where the conventional current collectors are an A1 foil with a thickness of 13 μm and a Cu foil with a thickness of 7 μm. Similarly, the thickness percent of the current collector refers to the percent by which the thickness of the current collector of the present application increases ⬆ or decreases ⬇ relative to the thickness of the A1 foil current collector with a thickness of 13 μm and the Cu foil current collector with a thickness of 7 μm.

The gravimetric energy density can be calculated according to the following formula: GED=capacity*voltage platform/cell weight.

For a given cell design system, the capacity and voltage platform can be considered fixed, and the weight of the cell directly affects GED. According to the present application, only the type and thickness of the current collector are changed inside the cell. The weight of the current collector can be calculated according to the area, thickness, and density of the current collector in a single cell, and the total thickness of the current collector can be calculated according to the thickness of the current collector and the number of layers designed for the cell, and then the change in GED can be obtained.

TABLE 3

| | | | Change in | Thickness | |
|---|---|---|---|---|---|
| | Current | Weight percent | gravimetric energy | percent of | Injection pass |
| | collector | of current | density of lithium | current | rate of lithium |
| Battery No. | No. | collector | battery | collector | battery |
| B1 | Current collector 1 | ↓52% | ↑3.2% | ↓23% | 9/15 |
| B2 | Current collector 2 | ↓52% | ↑3.2% | ↓23% | 11/15 |
| B3 | Current collector 3 | ↓52% | ↑3.2% | ↓23% | 11/15 |
| B4 | Current collector 4 | ↑67% | ↓4.2% | ↑208% | 12/15 |
| B5 | Current collector 5 | ↓69% | ↑4.3% | ↓54% | 10/15 |
| B6 | Current collector 6 | ↓52% | ↑3.3% | ↓23% | 13/15 |
| B7 | Current collector 7 | ↓52% | ↑3.3% | ↓23% | 14/15 |
| B8 | Current collector 8 | ↓45% | ↑2.8% | ↓8% | 12/15 |
| B9 | Current collector 9 | ↓59% | ↑3.7% | ↓35% | 13/15 |
| B10 | Current collector 10 | ↓56% | ↑3.5% | ↓31% | 13/15 |
| B11 | Current collector 11 | ↑5% | ↓0.3% | ↑31% | 11/15 |
| B12 | Current collector 12 | ↓71% | ↑4.4% | ↓45% | 12/15 |
| B13 | Current collector 13 | ↓56% | ↑3.5% | ↓31% | 13/15 |
| B14 | Current collector 14 | ↓56% | ↑3.5% | ↓31% | 11/15 |
| B15 | Current collector 15 | ↓56% | ↑3.5% | ↓31% | 14/15 |
| B16 | Current collector 16 | ↓56% | ↑3.5% | ↓31% | 14/15 |
| B17 | Current collector 17 | ↓73% | ↑7.8% | ↓7% | 13/15 |
| B18 | Current collector 18 | ↓56% | ↑3.5% | ↓31% | 15/15 |
| B19 | Current collector 19 | ↓56% | ↑3.5% | ↓31% | 15/15 |
| B20 | Current collector 20 | ↓56% | ↑3.5% | ↓31% | 14/15 |
| D1 | Current collector 1# | ↓61% | ↑3.8% | ↓38% | 0/15 |
| D2 | Current collector 2# | ↓76% | ↑8.1% | ↓21% | 0/15 |
| D3 | Current collector 3# | ↓56% | ↑3.5% | ↓31% | 2/15 |
| D4 | Current collector 4# | ↓56% | ↑3.5% | ↓31% | 1/15 |
| D5 | Current collector 5# | ↓56% | ↑3.5% | ↓31% | 6/15 |
| D6 | Current collector 6# | ↓56% | ↑3.5% | ↓31% | 5/15 |
| D7 | Current collector 7# | ↓52% | ↑3.2% | ↓23% | 2/15 |
| D8 | Current collector 8# | ↓52% | ↑3.2% | ↓23% | 5/15 |

“X/Y” in the table above indicates that X lithium-ion batteries among Y lithium-ion batteries pass the test.

It can be seen from Table 3 that in the case of the electrolyte injection test of the cold pressing of the current collector coating film, the pass numbers of the batteries B1-B20 are higher than the pass numbers of the batteries D1 and D2, and the current collectors in the batteries D1 and D2 are provided with no intermediate coating, and their pass numbers are 0. This is because batteries B1-B20 use the current collector of the present application. The arrangement of the intermediate coating in the current collector effectively enhances the adhesion between the metal layer and the polymer layer in the current collectors, and the overall electrolyte resistance of the current collector, thereby improving the pass rate of the electrolyte injection test.

In addition, compared with batteries D3 to D6, that is, compared with the intermediate coating using a single type of resin, the composite resin system constructed by the present application fully exerts the electrolyte resistance of the first resin and the adhesion of the second resin, so the pass numbers of the prepared batteries B1-B20 are higher than those of the batteries D6-D9. Similarly, although batteries D7-D8 provide an intermediate coating comprising two types of resins, they have the same or similar adhesion to the organic support layer or the conductive layer, and the same or similar electrolyte swelling resistance, so the pass numbers of batteries D7-D8 are less than the pass numbers of batteries B1-B20.

Furthermore, generally, in the batteries B1-B20 of the present application, the weight of the current collector and the thickness of the current collector are reduced, thereby improving the gravimetric energy density of the battery.

In addition, the present application also selects some current collectors for performance testing after immersion. As an example, the above-mentioned current collectors 1-10 and current collectors 1 #and 2 #-4 #were immersed in the electrolyte at 85° C. for 72 h for immersion performance testing. Specifically, all current collector samples were cut into strips with a length of 5 cm and a width of 2 cm, the strips were immersed in the electrolyte and packaged with aluminum-plastic films to remove environmental interference, and finally placed and held in a constant-temperature drying oven with a temperature of 85° C. for 72 h. Then, the current collectors were taken out to observe the appearance of the current collectors. The test results showed that most of the current collectors 1-10 had no aluminum layer peeling off, only the aluminum layer of the current collector 1 was slightly peeled off, and the aluminum layer of the current collector 2 was wrinkled; however, the aluminum powder of the current collector 1 #fell off in a large area, and aluminum layers peeled off from the current collectors 2 #-4 #in flakes. It thus can be seen that the use of the current collector of the present application enhances the interface adhesion and the overall electrolyte resistance of the current collector, and alleviates the delamination problem of the current collector.

Although the present application discloses the preferred embodiments as above, they are not provided to limit the claims. Any person skilled in the art can make some possible changes and modifications without departing from the concept of the present application. The scope of the present application shall be subject to the scope defined by the claims of the present application.

What is claimed is:

1. A current collector, comprising:
an organic support layer;
a conductive layer disposed on at least one surface of the organic support layer; and
an intermediate coating disposed between the organic support layer and the conductive layer;
wherein the intermediate coating comprises a resin composition, and the resin composition comprises a first resin and a second resin;
an adhesion of the first resin to the organic support layer is less than an adhesion of the second resin to the organic support layer; and
an adhesion of the first resin to the conductive layer is less than an adhesion of the second resin to the conductive layer.

2. The current collector according to claim 1, wherein the adhesion of the first resin to the organic support layer is within a range of 1.8N/15 mm to 2.5N/15 mm;
the adhesion of the second resin to the organic support layer is within a range of 3.5N/15 mm to 7.5N/15 mm.

3. The current collector according to claim 1, wherein the adhesion of the first resin to the conductive layer is within a range of 2.0N/15 mm to 5.5N/15 mm;
the adhesion of the second resin to the conductive layer is within a range of 3.5N/15 mm to 7.5N/15 mm.

4. The current collector according to claim 1, wherein a difference between a swelling ratio of the second resin in an electrolyte and a swelling ratio of the first resin in the electrolyte is greater than or equal to 3% by mass, based on soaking in the electrolyte at a temperature of 85° C. for 72 h.

5. The current collector according to claim 1, wherein the intermediate coating has at least one of the following characteristics:
a) a solubility parameter of the intermediate coating ranges from 7.5 to 12; or
b) a thermal expansion coefficient of the intermediate coating ranges from 50×10-6 K⁻¹ to 80×10⁻⁶ K⁻¹.

6. The current collector according to claim 1, wherein the first resin comprises one or more selected from the group consisting of polyacrylic resin (PAA), modified polyolefin resin (MPO) and organic silicone resin (OS); and the second resin comprises at least one selected from the group consisting of polyacrylate (PEA), polyurethane (PU), unsaturated polyester (UP), phenolic resin (PF), ethylene-acrylic acid copolymer (EAA), ethylene-vinyl acetate copolymer (EVA) and epoxy resin (EPO).

7. The current collector according to claim 1, wherein the first resin comprises epoxy resin (EPO); and the second resin comprises one or more selected from the group consisting of polyacrylate (PEA), polyurethane (PU), unsaturated polyester (UP), phenolic resin (PF), ethylene-acrylic acid copolymer (EAA), and ethylene-vinyl acetate copolymer (EVA).

8. The current collector according to claim 1, wherein the intermediate coating has at least one of the following characteristics:
c) a mass ratio of the first resin to the second resin is within a range of 2:98 to 98:2;
d) the first resin is a modified polyolefin resin, the second resin is polyurethane and/or epoxy resin, and a mass percent of the second resin in the resin composition is within a range of 2% to 30%; or
e) a thickness of the intermediate coating is within a range of 0.2 μm to 2 μm.

9. The current collector according to claim 1, wherein the organic support layer has at least one of the following characteristics:
f) the organic support layer comprises an organic polymer, and the organic polymer comprises one or more selected from the group consisting of polyethylene, polypropylene, polyethylene terephthalate, polybutylene terephthalate, polyethylene naphthalate, polyparaphenylene terephthalamide, polyimide, polycarbonate, polyetheretherketone, polyoxymethylene, poly(p-phenylene sulfide), poly(p-phenylene ether), polyvinyl chloride, polyamide, polytetrafluoroethylene, polyvinylidene fluoride, and polystyrene; or
g) a thickness of the organic support layer is within a range of 2 μm to 36 μm.

10. The current collector according to claim 1, wherein the conductive layer has at least one of the following characteristics:
h) the conductive layer comprises at least one of a metal conductive material or a carbon-based conductive material; the metal conductive material comprises one or more selected from the group consisting of aluminum, copper, nickel, iron, titanium, silver, gold, cobalt, chromium, molybdenum, and tungsten; and the carbon-based conductive material comprises one or more selected from the group consisting of graphite, acetylene black, graphene and carbon nanotubes; or
a thickness of the conductive layer is within a range of 100 nm to 5000 nm.

11. The current collector according to claim 1, wherein the conductive layer comprises a first conductive layer and a second conductive layer, and the first conductive layer and the second conductive layer are respectively disposed on two surfaces of the organic support layer;
the intermediate coating comprises a first intermediate coating and a second intermediate coating;
the first conductive layer, the first intermediate coating, the organic support layer, the second intermediate coating, and the second conductive layer are sequentially stacked.

12. An electrochemical apparatus, comprising a positive electrode, a negative electrode and an electrolyte, wherein the positive electrode and/or the negative electrode comprise(s) a current collector; the current collector comprising:
an organic support layer;
a conductive layer disposed on at least one surface of the organic support layer; and
an intermediate coating disposed between the organic support layer and the conductive layer;
wherein the intermediate coating comprises a resin composition, and the resin composition comprises a first resin and a second resin;
an adhesion of the first resin to the organic support layer is less than an adhesion of the second resin to the organic support layer; and
an adhesion of the first resin to the conductive layer is less than an adhesion of the second resin to the conductive layer.

13. The electrochemical apparatus according to claim 12, wherein the adhesion of the first resin to the organic support layer is within a range of 1.8N/15 mm to 2.5N/15 mm;
the adhesion of the second resin to the organic support layer is within a range of 3.5N/15 mm to 7.5N/15 mm.

14. The electrochemical apparatus according to claim 12, wherein the adhesion of the first resin to the conductive layer is within a range of 2.0N/15 mm to 5.5N/15 mm:
the adhesion of the second resin to the conductive layer is within a range of 3.5N/15 mm to 7.5N/15 mm.

15. The electrochemical apparatus according to claim 12, wherein a difference between a swelling ratio of the second resin in an electrolyte and a swelling ratio of the first resin in the electrolyte is greater than or equal to 3% by mass, based on soaking in the electrolyte at a temperature of 85° C. for 72 h.

16. The electrochemical apparatus according to claim 12, wherein the intermediate coating has at least one of the following characteristics:
a) a solubility parameter of the intermediate coating ranges from 7.5 to 12; or
b) a thermal expansion coefficient of the intermediate coating ranges from 50×10⁻⁶ K⁻¹ to 80×10⁻⁶ K⁴.

17. The electrochemical apparatus according to claim 12, wherein the first resin comprises one or more selected from the group consisting of polyacrylic resin (PAA), modified polyolefin resin (MPO) and organic silicone resin (OS), and the second resin comprises at least one selected from the group consisting of polyacrylate (PEA), polyurethane (PU), unsaturated polyester (UP), phenolic resin (PF), ethylene-acrylic acid copolymer (EAA), ethylene-vinyl acetate copolymer (EVA) and epoxy resin (EPO).

18. The electrochemical apparatus according to claim 12, wherein the first resin comprises epoxy resin (EPO); and the second resin comprises one or more selected from the group consisting of polyacrylate (PEA), polyurethane (PU), unsaturated polyester (UP), phenolic resin (PF), ethylene-acrylic acid copolymer (EAA), and ethylene-vinyl acetate copolymer (EVA).

19. The electrochemical apparatus according to claim 12, wherein the intermediate coating has at least one of the following characteristics:
c) a mass ratio of the first resin to the second resin is within a range of 2:98 to 98:2;
d) the first resin is a modified polyolefin resin, the second resin is polyurethane and/or epoxy resin, and a mass percent of the second resin in the resin composition is within a range of 2% to 30%; or
e) a thickness of the intermediate coating is within a range of 0.2 μm to 2 μm.

20. An electronic device, comprising the electrochemical apparatus according to claim 12.
